(19) United States
(12) Patent Application Publication
(10) Pub. No.: US 2025/0162257 A1
(43) Pub. Date: May 22, 2025

(54) THREE-DIMENSIONALLY SHAPING APPARATUS

(71) Applicant: SEIKO EPSON CORPORATION, Tokyo (JP)

(72) Inventors: Masaaki OGIHARA, MATSUMOTO-SHI (JP); Tatsuru SATO, SHIOJIRI-SHI (JP)

(21) Appl. No.: 18/951,926

(22) Filed: Nov. 19, 2024

(30) Foreign Application Priority Data
Nov. 22, 2023 (JP) 2023-198349

(51) Int. Cl. B29C 64/314; B29C 64/209; B33Y 30/00; B33Y 40/10

(52) U.S. Cl. CPC B29C 64/314; B29C 64/209; B33Y 30/00; B33Y 40/10

(57) ABSTRACT

The three-dimensionally shaping apparatus includes a plasticizer that plasticizes a material, a nozzle that discharges the plasticized material, and a controller that controls the plasticizer. The controller performs at least one of a first operation and a second operation. The first operation adjusts a rotational speed of a screw from a first speed to a greater second speed then adjusts the rotational speed of the screw to a third speed greater than the first speed but smaller than the second speed in order to adjust a discharge quantity of the plasticized material. The second operation adjusts the rotational speed of the screw from a fourth speed to a smaller fifth speed then adjusts the rotational speed of the screw to a sixth speed greater than the fifth speed but smaller than the fourth speed in order to adjust the discharge quantity of the plasticized material.

The present application is based on, and claims priority from JP Application Serial Number 2023-198349, filed Nov. 22, 2023, the disclosure of which is hereby incorporated by reference herein in its entirety.

### BACKGROUND

### 1. Technical Field

The present disclosure relates to a three-dimensionally shaping apparatus.

### 2. Related Art

JP-A-2019-081263 discloses a three-dimensionally shaping apparatus including a flow rate adjusting mechanism capable of controlling the quantity of a molten material discharged from a nozzle.

JP-A-2019-081263 is an example of the related art.

The three-dimensionally shaping apparatus disclosed in JP-A-2019-081263 can adjust the quantity of the material discharged from the nozzle by adjusting the angle of rotation of a butterfly valve serving as the flow rate adjusting mechanism. However, when the quantity of the material discharged from the nozzle is controlled by the flow rate adjusting mechanism, the pressure in a channel upstream from the flow rate adjusting mechanism is not stabilized in some cases, so that it takes time to stabilize a discharge quantity of the material.

### SUMMARY

According to a first aspect of the present disclosure, a three-dimensional shaping apparatus is provided. The three-dimensionally shaping apparatus includes a plasticizer that includes a screw and a motor that rotates the screw and plasticizes a material to produce a plasticized material; a nozzle that has a nozzle opening and discharges the plasticized material; and a controller that controls the plasticizer, and the controller performs at least one of a first operation and a second operation, the first operation adjusting a rotational speed of the screw from a first speed to a second speed greater than the first speed and then adjusting the rotational speed of the screw to a third speed greater than the first speed but smaller than the second speed in order to adjust a discharge quantity of the plasticized material discharged from the nozzle from a first discharge quantity to a second discharge quantity greater than the first discharge quantity, the second operation adjusting the rotational speed of the screw from a fourth speed to a fifth speed smaller than the fourth speed and then adjusting the rotational speed of the screw to a sixth speed greater than the fifth speed but smaller than the fourth speed in order to adjust the discharge quantity of the plasticized material discharged from the nozzle from a third discharge quantity to a fourth discharge quantity smaller than the third discharge quantity.

### BRIEF DESCRIPTION OF THE DRAWINGS

FIG. 1 is a descriptive view showing a schematic configuration of a three-dimensionally shaping apparatus according to a first embodiment.

FIG. 2 is a perspective view of a screw.

FIG. 3 is a schematic plan view of a barrel.

FIG. 4 is a descriptive view diagrammatically showing that a three-dimensionally shaped object is shaped.

FIG. 5 is a flowchart of a three-dimensional shaping process.

FIG. 6 is a descriptive view showing an example of a partially shaped object.

FIG. 7 is a timing chart of movement speed data and discharge control parameters.

FIG. 8 includes graphs showing a result of a simulation of changes in pressure.

FIG. 9 shows temporal changes in a rotational speed of the screw in a second embodiment.

FIG. 10 is a descriptive view of an undershooting phenomenon.

FIG. 11 shows temporal changes in a movement speed of a nozzle in a third embodiment.

### DESCRIPTION OF EMBODIMENTS

### A. First Embodiment

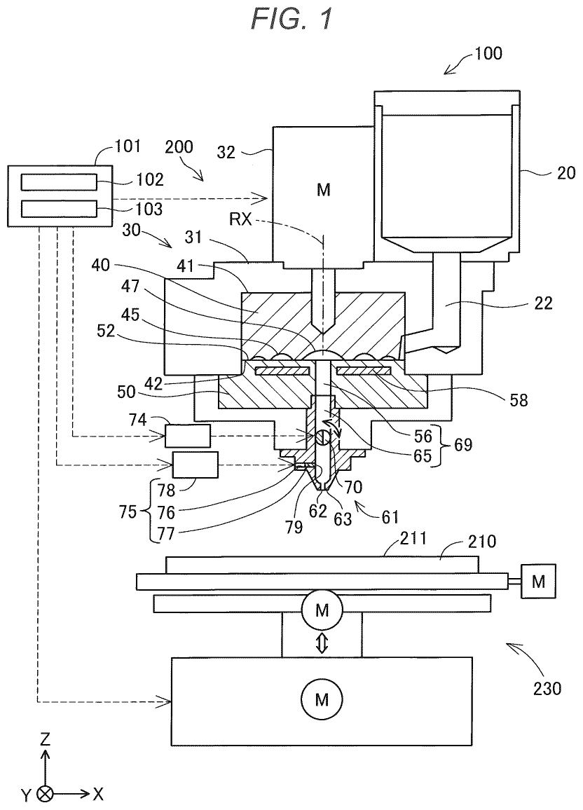

FIG. 1 is a descriptive view showing a schematic configuration of a three-dimensionally shaping apparatus 100 according to a first embodiment. FIG. 1 shows arrows along X, Y and Z directions perpendicular to one another. The X, Y, and Z directions are directions along an X-axis, a Y-axis, and a Z-axis that are three axes in a space that are perpendicular to one another, and each include both a direction toward one side along the corresponding one of the X-axis, the Y-axis, and the Z-axis and the opposite direction of the direction toward the one side. The X-axis and the Y-axis are axes along a horizontal plane, and the Z-axis is an axis along a vertical line. Also in the other drawings, the arrows along the X, Y, and Z directions are shown as appropriate. The X, Y and Z directions in FIG. 1 and the X, Y and Z directions in the other figures indicate the same directions. In the following description, a +Z direction is also referred to as “upper”, and a −Z direction is also referred to as “lower”.

The three-dimensionally shaping apparatus 100 includes a controller 101, which controls the three-dimensionally shaping apparatus 100, a discharger 200, which produces and discharges a plasticized material, a shaping stage 210, which serves as a base for a three-dimensionally shaped object, and a position changer 230, which controls the position where the plasticized material is discharged.

The discharger 200 discharges the plasticized material, which is a material as a result of plasticizing a solid-state material into a material in the form of paste, onto the stage 210 under the control of the controller 101. The discharger 200 includes a material feeder 20, which is a source that feeds the material before being transformed into the plasticized material, a plasticizer 30, which plasticizes at least a part of the material to produce the plasticized material, a channel 69, through which the produced plasticized material flows, a nozzle 61, which communicates with the channel 69 and from which the plasticized material is discharged, a discharge controller 70, which is provided in the channel 69, and a suction/delivery section 75, which is provided in the channel 69. The channel 69 communicates with a nozzle opening 62 of the nozzle 61, which will be described later.

The material feeder 20 houses the material in the form of pellets, powder, or the like. In the present embodiment, thermoplastic resin formed in pellets is used s the material. The material is, for example, acrylonitrile butadiene styrene (ABS), polyetheretherketone (PEEK), or polypropylene (PP). The material feeder 20 in the present embodiment is configured with a hopper. A feeding path 22, which couples the material feeder 20 and the plasticizer 30 to each other, is provided below the material feeder 20. The material feeder 20 feeds the material to the plasticizer 30 through the feeding path 22.

The plasticizer 30 includes a screw case 31, a motor 32, a screw 40, and a barrel 50. The plasticizer 30 plasticizes at least a part of the material fed from the material feeder 20 to produce the plasticized material in the form of paste showing fluidity. The plasticizer 30 then feeds the produced plasticized material to the nozzle 61. The term “plasticizing” is a concept including melting and means changing a solid state to a flowable state. Specifically, in the case of a material that experiences glass transition, plasticizing means raising the temperature of the material to the glass transition point or higher. In the case of a material that does not experience glass transition, plasticizing means raising the temperature of the material to the melting point or higher. The screw 40 in the present embodiment may be called a flat screw or a scroll.

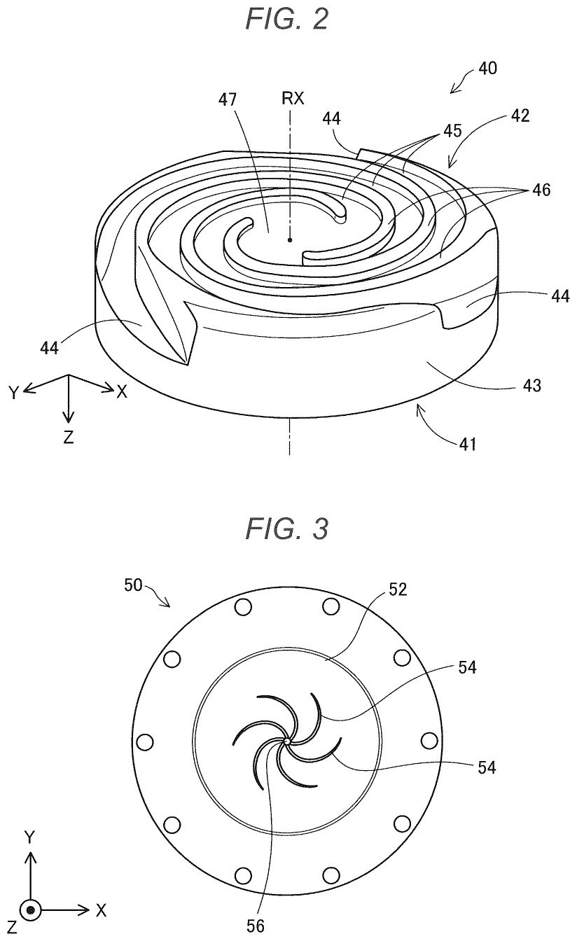

FIG. 2 is a perspective view showing a schematic configuration of the screw 40. FIG. 3 is a schematic plan view showing the barrel 50. The screw 40 has a substantially cylindrical shape with the length in the axial direction that is the direction along a center axis RX thereof being smaller than the length in the direction perpendicular to the axial direction. The screw 40 is so disposed that the center axis RX, which is the center of rotation thereof, is parallel to the Z direction.

The screw 40 is housed in the screw case 31, as shown in FIG. 1. A portion of the screw 40 that faces an upper surface 41 thereof is linked to the motor 32. The screw 40 is rotated in the screw case 31 by the rotational driving force produced by the motor 32. The screw 40 may be driven by the motor 32 via a decelerator.

The rotational speed of the screw 40 is controlled by the controller 101. To increase the quantity of the plasticized material discharged from the nozzle 61, the controller 101 increases the rotational speed of the screw 40. To decrease the quantity of the plasticized material discharged from the nozzle 61, the controller 101 decreases the rotational speed of the screw 40.

Vortex grooves 45 are formed in a screw lower surface 42, as shown in FIG. 2. The feeding path 22 described above and coupled to the material feeder 20 communicates with the grooves 45 via a side surface 43 of the screw 40. The grooves 45 are continuously extend to material introduction ports 44 formed in the side surface 43 of the screw 40. The material introduction ports 44 are portions that receive the material fed through the feeding path 22 coupled to the material feeder 20. In the present embodiment, three groove 45 are formed so as to be separated from each other by protruding rows 46, as shown in FIG. 2. The number of grooves 45 is not limited to three and may be one or two or may be four or more. The grooves 45 do not necessarily have vortex shapes and may have spiral shapes or the shapes of involute curves, or may have shapes extending arcuately from a central section 47 toward the outer circumference.

The barrel 50 is disposed below the screw 40, as shown in FIG. 1. A barrel upper surface 52 faces the screw lower surface 42, and a space is formed between the grooves 45 in the screw lower surface 42 and the barrel upper surface 52. The barrel 50 is provided with a communication hole 56, which communicates with the nozzle 61, which will be described later, on the central axis RX of the screw 40, as shown in FIG. 3. In the present embodiment, the communication hole 56 forms a part of the channel 69 described above. Multiple guide grooves 54 are formed in the barrel upper surface 52, are coupled to the communication hole 56, and extend in the form of vortices from the communication hole 56 toward the outer circumference. One end of each of the guide grooves 54 may not be coupled to the communication hole 56. The guide grooves 54 may be omitted. A heater 58 is built in the barrel 50 at a position where the heater faces the grooves 45 of the screw 40. The temperature of the heater 58 is controlled by the controller 101.

The material fed into the grooves 45 of the screw 40 is caused to flow along the grooves 45 by the rotation of the screw 40 while being plasticized in the grooves 45 and is guided as the plasticized material to the central section 47 of the screw 40. The plasticized material in the form of paste having flowed into the central section 47 and showing fluidity is fed to the nozzle 61 through the communication hole 56. Note that all kinds of substances that constitute the plasticized material may not be plasticized. The plasticized material only needs to be transformed into a state showing fluidity as a whole with at least a part of substances that constitute the plasticized material plasticized.

The nozzle 61 has a nozzle channel 65 and a front end surface 63 provided with the nozzle opening 62, as shown in FIG. 1. The nozzle channel 65 is a channel which is formed in the nozzle 61 and through which the plasticized material flows, and forms a part of the channel 69 described above. The front end surface 63 is a surface that constitutes a front end portion of the nozzle 61 that protrudes in the −Z direction toward a shaping surface 211. The nozzle opening 62 is a portion provided at the end of the nozzle channel 65 that faces and communicates with the atmosphere, that is, the end facing the front end surface 63 and having a cross section smaller than that of the nozzle channel 65. The plasticized material produced by the plasticizer 30 is discharged through the channel 69 via the nozzle opening 62. A heater that suppresses a decrease in temperature of the plasticized material discharged onto the stage 210 may be disposed around the nozzle 61.

The discharge controller 70 controls the discharge of the plasticized material from the nozzle 61 by controlling the area of the opening of the channel 69. The discharge controller 70 in the present embodiment is configured with a valve and is provided in the nozzle channel 65. The discharge controller 70 rotates in the nozzle channel 65 to change the opening of the nozzle channel 65. The discharge controller 70 is driven by a first driver 74 under the control of the controller 101. The first driver 74 is configured, for example, with a stepper motor. The controller 101 controls control whether the plasticized material is caused to flow out by using the first driver 74 to control the angle of rotation of the valve.

The suction/delivery section 75 includes a branch channel 76, a plunger 77, and a second driver 78. The branch channel 76 is coupled to the channel 69 between the discharge controller 70 and the nozzle opening 62, that is, a portion of the channel 69 that is located between the discharge controller 70 and the nozzle opening 62. In the present embodiment, the branch channel 76 is formed by a cylinder coupled to the nozzle channel 65, and extends in the −X direction from a portion where the branch channel 76 is coupled to the nozzle channel 65. The plunger 77 is driven by the second driver 78 under the control of the controller 101 to move in the branch channel 76. The second driver 78 is configured, for example, with a stepper motor and a rack-and-pinion mechanism that converts the rotational force produced by the stepper motor into a translational motion of the plunger 77.

The controller 101 controls the suction/delivery section 75 to change the position of the plunger 77 to perform a suction operation and a delivery operation. The suction operation refers to the operation of suctioning the plasticized material in the channel 69 into the branch channel 76. The delivery operation refers to the operation of delivering the plasticized material suctioned into the branch channel 76 to the channel 69. In the present embodiment, the controller 101 causes the plunger 77 to retreat in a direction away from the channel 69 in the suction operation, and advances the plunger 77 in a direction toward the channel 69 in the delivery operation.

The controller 101 can reduce the pressure in the channel 69 by performing the suction operation to suppress a tailing phenomenon in which the plasticized material drips down in the form of a string via the nozzle opening 62. In this case, the controller 101 can more effectively suppress the tailing phenomenon by performing the suction operation after the discharge controller 70 makes the opening of the nozzle channel 65 zero. In addition, the controller 101 can increase the responsiveness of the delivery of the plasticized material via the nozzle opening 62 by performing the delivery operation to increase the pressure in the channel 69. For example, when starting the discharge from the nozzle 61, the controller 101 can increase the responsiveness of the delivery of the plasticized material by performing the delivery operation before the discharge controller 70 makes the opening of the nozzle channel 65 greater than zero.

The stage 210 is disposed at a position where the stage 210 faces the nozzle 61. The three-dimensionally shaping apparatus 100 shapes a three-dimensionally shaped object by discharging the plasticized material via the nozzle opening 62 onto the shaping surface 211 of the stage 210 to stack layers on each other. The region where a three-dimensionally shaped object is shaped out of the shaping surface 211 and the region above the shaping surface 211 is also called a shaping region.

The position changer 230 changes the positional relationship between the nozzle 61 and the stage 210. In the present embodiment, the position changer 230 moves the stage 210 with respect to the nozzle 61. Note that the change in the position of the nozzle 61 with respect to the stage 210 may be simply called movement of the nozzle 61 or scanning with the nozzle 61. In the present embodiment, for example, the movement of the stage 210 in the +X direction can also be expressed as the movement of the nozzle 61 in the −X direction. The relative movement speed of the nozzle 61 with respect to the stage 210 is also called a relative movement speed of the nozzle 61. The relative movement speed of the nozzle 61 is also simply called a movement speed of the nozzle 61 or a movement speed. The position changer 230 in the present embodiment is configured with a three-axis positioner that moves the stage 210 in the three axial directions, X, Y, and Z directions, with driving forces produced by three motors. The motors are each driven under the control of the controller 101. Note that the position changer 230 may not be configured to move the stage 210 and may instead be configured to move the nozzle 61 with the stage 210 not moved. Still instead, the position changer 230 may be configured to move both the stage 210 and the nozzle 61.

The controller 101 is configured with a computer including a processor 102, a storage 103, and an input/output interface that inputs and outputs signals from and to an external apparatus. In the present embodiment, the processor 102 executes a program or instructions stored in the storage 103 to allow the controller 101 to perform various functions such as the function of carrying out a three-dimensional shaping process of shaping a three-dimensionally shaped object. Note that the controller 101 may be configured with a combination of multiple circuits instead of being configured with a computer.

In the three-dimensional shaping process, the controller 101 controls the discharger 200 and the position changer 230 in accordance with shaping data to shape a shaped object in the shaping region on the shaping surface 211. The shaping data contains shaping path data representing a movement path of the nozzle 61 with respect to the stage 210, and discharge quantity data representing a discharge quantity associated with the shaping path data. The discharge quantity refers to the quantity of the plasticized material discharged per unit time via the nozzle opening 62.

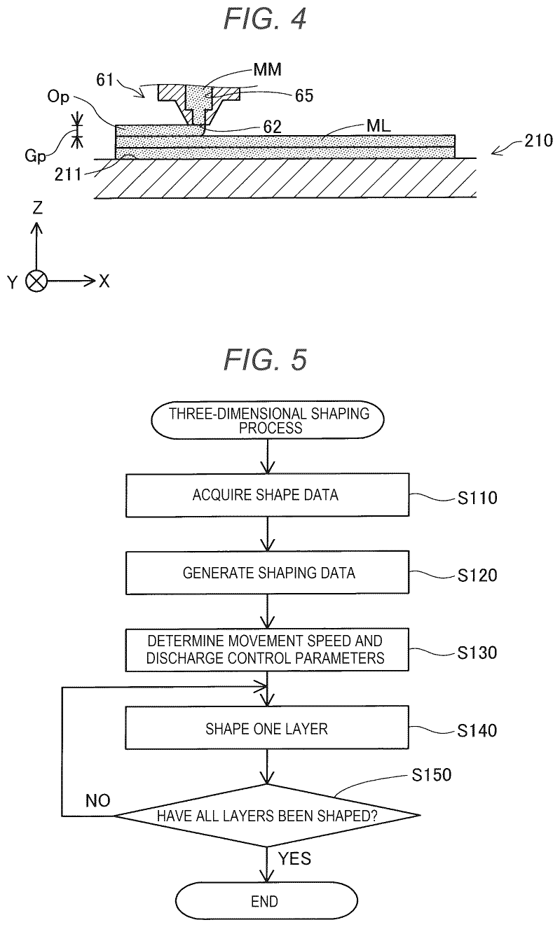

FIG. 4 is a descriptive view diagrammatically showing that the three-dimensionally shaping apparatus 100 shapes a three-dimensionally shaped object. In the three-dimensionally shaping apparatus 100, the plasticizer 30 plasticizes the solid-state material fed to the grooves 45 of the rotating screw 40 to produce a plasticized material MM, as described above. The controller 101 causes the nozzle 61 to discharge the plasticized material MM with the distance between the shaping surface 211 of the stage 210 and the nozzle 61 maintained while changing the position of the nozzle 61 with respect to the stage 210 in the direction along the shaping surface 211 of the stage 210. The plasticized material MM discharged from the nozzle 61 is continuously deposited in the direction in which the nozzle 61 is moved. Scanning the shaping surface 211 with the nozzle 61 as described above shapes a shaped portion extending linearly along the scanning path of the nozzle 61. Such a single continuously shaped portion of the three-dimensionally shaped object is also called a partially shaped object Op.

The controller 101 repeats the aforementioned scanning with the nozzle 61 to form a layer ML. After forming one layer ML, the controller 101 moves the position of the nozzle 61 with respect to the stage 210 in the Z direction. The controller 101 then further stack another layer ML on the layer ML that has been formed to shape a three-dimensional shaped object. When stacking a layer of the plasticized material, the controller 101 causes the plasticized material to be discharged from the nozzle 61 while maintaining the distance between the nozzle 61 and a discharge target. The discharge target is the shaping surface 211 when the plasticized material is discharged onto the shaping surface 211, and is the upper surface of the already discharged plasticized material when the plasticized material is discharged onto the already discharged plasticized material. The distance between the nozzle 61 and the discharge target may be called a gap Gp.

The width of the partially shaped object Op described above is also called a linewidth, and the height of the partially shaped object Op is also called a stacking interval. The linewidth and the stacking interval are determined by the size of the gap Gp described above and the quantity of the plasticized material discharged from the nozzle 61 per unit amount of movement. For example, when the gap Gp is small, the plasticized material discharged from the nozzle 61 is pressed by a greater degree against the discharge target by the nozzle 61 than when the gap Gp is large, resulting in a small stacking interval and a large linewidth. The quantity of the plasticized material discharged from the nozzle 61 per unit amount of movement is determined by the movement speed of the nozzle 61 and the discharge quantity of the plasticized material.

FIG. 5 is a flowchart of the three-dimensional shaping process carried out by the controller 101. In step S110, the controller 101 acquires shape data representing the shape of a three-dimensionally shaped object from an external computer, a recording medium, or the like. The controller 101 acquires the shape data such as three-dimensional CAD data from an external apparatus, for example, via a network or a recording medium.

In step S120, the controller 101 generates shaping data used to shape a three-dimensionally shaped object indicated by the three-dimensional data acquired in step S110 based on the three-dimensional data. In more detail, in step S120, the controller 101 generates the shaping path data and the discharge quantity data described above. In another embodiment, instead of executing steps S110 and S120 to generate shaping data, the controller 101 may, for example, externally acquire shaping data generated by an external information processing apparatus via a network or a recording medium.

In step S130, the controller 101 determines movement speed data and discharge control parameters. The movement speed data represents the movement speed of the nozzle 61 in each movement path contained in the shaping path data. The discharge control parameters represent parameters used to control the discharge quantity of the plasticized material and the suction/delivery section 75 in each movement path. Instead, the movement speed data and the discharge control parameters to be determined in step S130 may be contained in the shaping data or may be generated as data different from the shaping data. Still instead, the movement speed data and the discharge control parameters may be generated by an external information processing apparatus.

In step S140, the controller 101 controls the discharger 200 and the position changer 230 based on the shaping data generated in step S120, and the movement speed data and the discharge control parameters generated in step S130 to shape one of the multiple layers that constitute the three-dimensionally shaped object. In more detail, in step S140, the controller 101 shapes one or more partially shaped objects that constitute one layer of the three-dimensionally shaped object in the shaping region on the shaping surface 211. In step S140, the controller 101 shapes the layers while adjusting the discharge quantity of the plasticized material by controlling the rotational speed of the screw 40 and causing the suction/delivery section 75 to control the plunger 77 while controlling the discharge controller 70 to fully open the nozzle channel 65.

In step S150, the controller 101 determines whether all layers of the three-dimensionally shaped object have been shaped. When the controller 101 determines that all layers of the three-dimensionally shaped object have not been shaped, the controller 101 returns the process in step S140 and carrying out the process of shaping the next layer. When the controller 101 determines that all the layers have been shaped, the controller 101 terminates the three-dimensional shaping process.

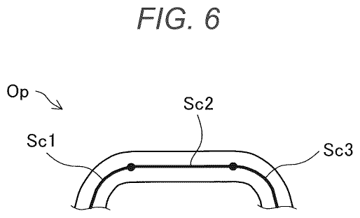

FIG. 6 is a descriptive view showing an example of the partially shaped object in the present embodiment. FIG. 6 diagrammatically shows a part of the partially shaped object Op, which forms a certain layer of the three-dimensionally shaped object. FIG. 6 shows a first shaped segment Sc1, a second shaped segment Sc2, and a third shaped segment Sc3 as shaped segments that constitute the partially shaped object Op.

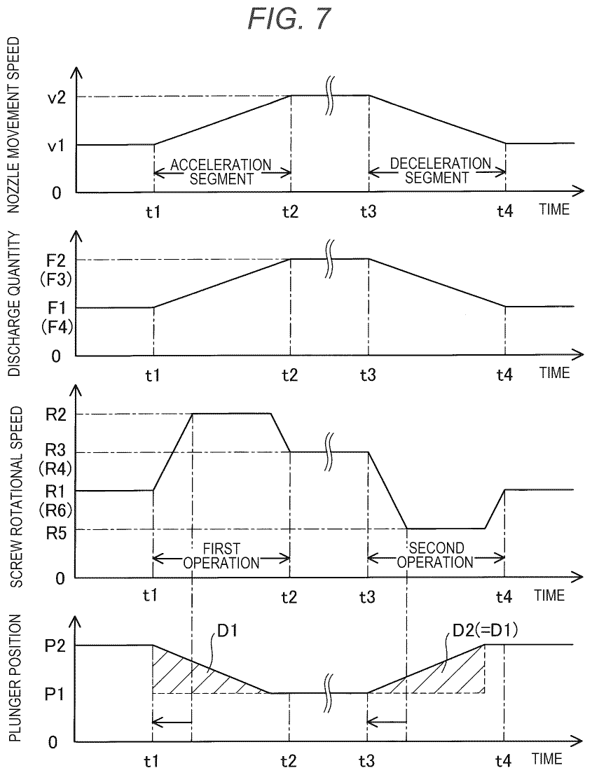

FIG. 7 is a timing chart for describing the movement speed data and the discharge control parameters in the present embodiment. FIG. 7 includes graphs showing temporal changes in the movement speed of the nozzle 61, temporal changes in the discharge quantity, temporal changes in the rotational speed of the screw 40, and temporal changes in the position of the plunger 77 in the operation of shaping the partially shaped object Op shown in FIG. 6.

In the present embodiment, the controller 101 can control the position changer 230 based on the movement speed data to change the movement speed of the nozzle 61 to at least a first movement speed v1 and a second movement speed v2. The second movement speed v2 is a movement speed greater than the first movement speed v1. For example, the controller 101 sets the movement speed of the nozzle 61 to the first movement speed v1 when shaping the curved shaped segments Sc1 and Sc3 shown in FIG. 6, and sets the movement speed of the nozzle 61 to the second movement speed v2 when shaping the linear shaped segment Sc2. That is, the shaped segment Sc1 is shaped before the timing t1 shown in FIG. 7, the shaped segment Sc2 is shaped in the period from the timing t1 to the timing t4, and the shaped segment Sc3 is shaped after the timing t4. The period from the timing t1 to the timing t2 is an acceleration segment in which the movement speed of the nozzle 61 is accelerated, and the period from the timing t3 to the timing t4 is a deceleration segment in which the movement speed of the nozzle 61 is decelerated.

The controller 101 increases the quantity of the plasticized material discharged from the nozzle 61 as the movement speed of the nozzle 61 increases to suppress fluctuation of the width of the plasticized material deposited at the stage 210. For example, the controller 101 sets the discharge quantity to a first discharge quantity F1 when the movement speed of the nozzle 61 is the first movement speed v1, and sets the discharge quantity to a second discharge quantity F2 when the movement speed of the nozzle 61 is the second movement speed v2, as shown in FIG. 7. The second discharge quantity F2 is greater than the first discharge quantity F1.

The controller 101 adjusts the discharge quantity of the plasticized material by controlling the rotational speed of the screw 40. In the present embodiment, to adjust the quantity of the plasticized material discharged from the nozzle 61 from the first discharge quantity F1 to the second discharge quantity F2 based on the discharge control parameters, the controller 101 performs a “first operation” of adjusting the rotational speed of the screw 40 from a first speed R1 to a second speed R2 and then adjusting the rotational speed to a third speed R3. The second speed R2 is greater than the first speed R1. The third speed R3 is greater than the first speed R1 but smaller than the second speed R2.

To adjust the quantity of the plasticized material discharged from the nozzle 61 from a third discharge quantity F3 to a fourth discharge quantity F4, which is smaller than the third discharge quantity F3, based on the discharge control parameters, the controller 101 performs a “second operation” of adjusting the rotational speed of the screw 40 from a fourth speed R4 to a fifth speed R5 and then adjusting the rotational speed to a sixth speed R6. The fifth speed R5 is smaller than the second speed R2. The sixth speed R6 is greater than the fifth speed R5 but smaller than the fourth speed R4. In the present embodiment, the third discharge quantity F3 is equal to the second discharge quantity F2, and the fourth discharge quantity F4 is equal to the first discharge quantity F1. The fourth speed R4 is equal to the third speed R3, and the sixth speed R6 is equal to the first speed R1.

In the present embodiment, the controller 101 performs the first operation described above in the acceleration segment, in which the relative movement speed of the nozzle 61 is accelerated from the first movement speed v1 to the second movement speed v2, as shown in FIG. 7. The controller 101 performs the second operation described above in the deceleration segment, in which the relative movement speed of the nozzle 61 is decelerated from the second movement speed v2 to the first movement speed v1.

The controller 101 controls the suction/delivery section 75 to move the plunger 77 in the branch channel 76, to perform the delivery operation of delivering the plasticized material from the branch channel 76 to the channel 69 in the acceleration segment and the suction operation of suctioning the plasticized material from the channel 69 to the branch channel 76 in the deceleration segment. That is, the controller 101 performs the operation of pressing the plunger 77 so as to approach the channel 69 in the acceleration segment, and performs the operation of pulling the plunger 77 so as to move away from the channel 69 in the deceleration segment. The plunger position shown in FIG. 7 represents the X-direction coordinate of the position of an end surface 79 of the plunger 77 shown in FIG. 1, which faces the positive end of the X direction. In FIG. 7, when the plunger position is zero, the end surface 79 of the plunger 77 is located at a position closest to the channel 69.

In the present embodiment, the controller 101 matches a first amount of movement D1, which is the amount of movement of the plunger 77 in the acceleration segment, with a second amount of movement D2, which is the amount of movement of the plunger 77 in the deceleration segment. In FIG. 7, the first amount of movement D1 and the second amount of movement D2 are each hatched. In the present disclosure, the term “matching” means that the difference between the first amount of movement D1 and the second amount of movement D2 falls within a range of 10%. The difference between the first amount of movement D1 and the second amount of movement D2 more preferably falls within a range of 5%. It is more preferable that the first amount of movement D1 and the second amount of movement D2 coincide with each other.

In the present embodiment, to perform the first operation in the acceleration segment, the controller 101 carries out the process of transmitting to the suction/delivery section 75 an operation instruction to move the plunger 77 before the timing at which the rotational speed of the screw 40 reaches the second speed R2. Specifically, in the present embodiment, the controller 101 transmits to the suction/delivery section 75 an operation instruction to cause the plunger 77 to perform the delivery operation at the same time as the timing t1, at which the acceleration of the rotational speed starts.

In the present embodiment, to perform the second operation in the deceleration segment, the controller 101 carries out the process of transmitting to the suction/delivery section 75 an operation instruction to move the plunger 77 before the timing at which the rotational speed of the screw 40 reaches the fifth speed R5. Specifically, in the present embodiment, the controller 101 transmits to the suction/delivery section 75 an operation instruction to cause the plunger 77 to perform the suction operation at the same time as the timing t3, at which the deceleration of the rotational speed starts.

The storage 103 provided in the controller 101 stores the movement speed of the nozzle 61, the discharge quantity, the rotational speed of the screw 40, and the position of the plunger 77 in the form of a function or a map having the relationship shown in FIG. 7. In step S130 described above, the controller 101 determines the movement speed data and the discharge control parameters by using the function or the map stored in the storage 103 to control the discharge of the plasticized material in such a way that the linewidth does not fluctuate even when the movement speed of the nozzle 61 fluctuates.

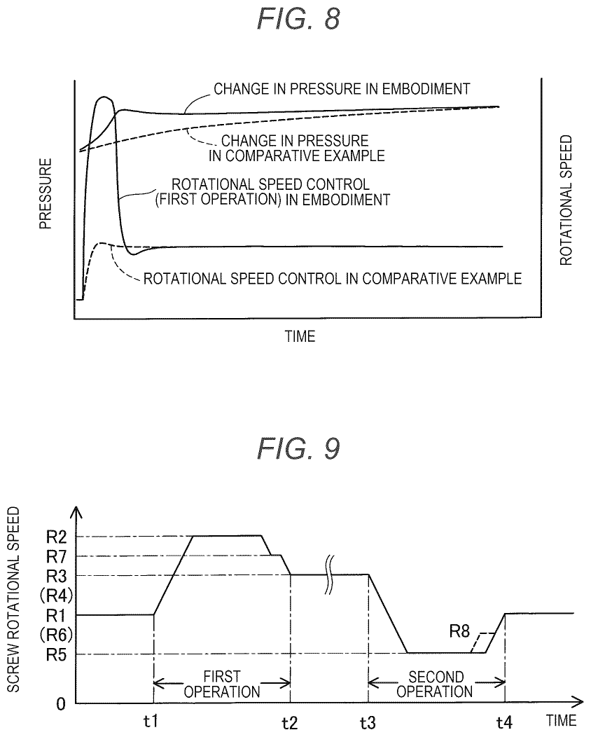

FIG. 8 includes graphs showing the result of a simulation of changes in pressure in the channel 69 that result from the first operation described above. FIG. 8 shows the result of an experiment: which the first operation described above for the rotational speed of the screw 40 is performed, and further shows, as Comparative Example, the result of an experiment in which the rotational speed of the screw 40 is directly changed from the first speed R1 to the third speed R3 without via the second speed R2, unlike the first operation. In Comparative Example, even when the rotational speed of the screw 40 was increased from the first speed to the third speed, the pressure of the plasticized material in the channel 69 did not increase immediately, but increased moderately. In contrast, when the rotational speed of the screw 40 was temporarily changed from the first speed R1 to the second speed R2, which is greater than the first speed R1 and the third speed R3, before the rotational speed was changed from the first speed R1 to the third speed R3 in accordance with the first operation, the pressure of the plasticized material in the channel 69 increased significantly faster than that in Comparative Example, and was then quickly stabilized.

The three-dimensionally shaping apparatus 100 according to the present embodiment described above performs the first operation to adjust the discharge quantity of the plasticized material from the first discharge quantity to the second discharge quantity, which is greater than the first discharge quantity. In the first operation, the rotational speed of the screw 40 is adjusted from the first speed R1 to the second speed R2, which is greater than the first speed R1, and then adjusted to the third speed R3, which is greater than the first speed R1 but smaller than the second speed R2. The discharge quantity can therefore be quickly stabilized when the discharge quantity is increased. The three-dimensionally shaping apparatus 100 further performs the second operation to adjust the discharge quantity of the plasticized material from the third discharge quantity to the fourth discharge quantity, which is smaller than the third discharge quantity. In the second operation, the rotational speed of the screw 40 is adjusted from the fourth speed R4 to the fifth speed R5, which is smaller than the fourth speed R4, and then adjusted to the sixth speed R6, which is greater than the fifth speed R5 but smaller than the fourth speed R4. The discharge quantity can therefore be quickly stabilized when the discharge quantity is decreased.

The three-dimensionally shaping apparatus 100 according to the present embodiment performs the first operation in the acceleration segment, in which the relative movement speed of the nozzle 61 is accelerated from the first movement speed v1 to the second movement speed v2, and performs the second operation in the deceleration segment, in which the relative movement speed of the nozzle 61 is decelerated from the second movement speed v2 to the first movement speed v1. The three-dimensionally shaping apparatus 100 then moves the plunger 77 in the branch channel 76 to perform the operation of delivering the plasticized material from the branch channel 76 to the channel 69 in the acceleration segment and the operation of suctioning the plasticized material from the channel 69 to the branch channel 76 in the deceleration segment. In this process, the three-dimensionally shaping apparatus 100 matches the amount of movement of the plunger 77 in the acceleration segment with the amount of movement of the plunger 77 in the deceleration segment. The thus configured three-dimensionally shaping apparatus 100 can suppress a situation in which the amount of movement of the plunger 77 in the direction toward the channel 69 and the amount of movement of the plunger 77 in the direction away from the channel 69 deviate from each other. As a result, the position of the plunger 77 can be accurately controlled over a long period of time. As a result, the shaping accuracy of the three-dimensionally shaped object can be increased.

To perform the first operation in the acceleration segment, the three-dimensionally shaping apparatus 100 according to the present embodiment carries out the process of transmitting to the suction/delivery section 75 the operation instruction to move the plunger 77 before the timing of changing the rotational speed of the screw 40 to the second speed R2. The plasticized material can therefore be quickly fed into the channel 69 when the nozzle 61 is accelerated. The thus configured three-dimensionally shaping apparatus 100 can suppress a temporary decrease in the linewidth due to an insufficient discharge quantity during the acceleration of the nozzle 61. To perform the second operation in the deceleration segment, the three-dimensionally shaping apparatus 100 carries out the process of transmitting to the suction/delivery section 75 the operation instruction to move the plunger 77 before the timing at which the rotational speed of the screw 40 is changed to the fifth speed R5. The plasticized material can be therefore quickly suctioned from the channel 69 when the nozzle 61 is decelerated. The thus configured three-dimensionally shaping apparatus 100 can suppress a temporary thick linewidth due to an excessive discharge quantity during the deceleration of the nozzle 61.

### B. Second Embodiment

The configuration of the three-dimensionally shaping apparatus 100 according to a second embodiment is the same as that of the three-dimensionally shaping apparatus 100 according to the first embodiment. In the first and second embodiments, the rotational speed of the screw 40 in the first operation is controlled differently, but the other controlled items are the same in the first and second embodiments.

FIG. 9 shows temporal changes in the rotational speed of the screw 40 in the second embodiment. In the second embodiment, the controller 101 adjusts in the first operation the rotational speed of the screw 40 from the first speed R1 to the second speed R2, then adjusts the rotational speed of the screw 40 to a seventh speed R7, which is smaller than the second speed R2 but greater than the third speed R3, and then adjusts the rotational speed of the screw 40 from the seventh speed R7 to the third speed R3.

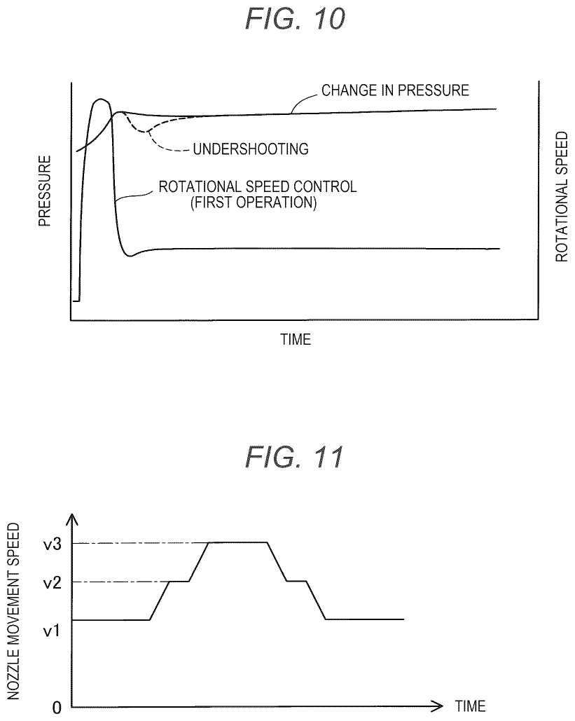

According to the second embodiment described above, the rotational speed of the screw 40 can be reduced stepwise from the second speed R2 to the third speed R3 via the seventh speed R7. Therefore, when the rotational speed of the screw 40 is reduced from the second speed R2 to the third speed R3, occurrence of an undershooting phenomenon in which the pressure of the plasticized material in the channel 69 drops excessively can be suppressed, as indicated by the broken line in FIG. 10. The discharge quantity can therefore be quickly stabilized when the rotational speed of the screw 40 is decreased in the first operation.

In the present embodiment, the controller 101 reduces the rotational speed of the screw 40 from the second speed R2 to the third speed R3 via the seventh speed R7. That is, the controller 101 decreases the rotational speed of the screw 40 in two stages. The controller 101 may instead decrease the rotational speed of the screw 40 in three or more stages.

Furthermore, the controller 101 may adjust in the second operation the rotational speed of the screw 40 from the fourth speed R4 to the fifth speed R5, then adjust the rotational speed of the screw 40 to an eighth speed R8, which is greater than the fifth speed R5 but smaller than the sixth speed R6, and then adjust the rotational speed of the screw 40 from the eighth speed R8 to the sixth speed R6, as indicated by the broken line in FIG. 9. The thus operating controller 101 is likely to stabilize the discharge quantity when increasing the rotational speed of the screw 40 from the fifth speed R5 to the sixth speed R6.

### C. Third Embodiment

The configuration of the three-dimensionally shaping apparatus 100 according to a third embodiment is the same as that of the three-dimensionally shaping apparatus 100 according to the first embodiment. The third embodiment differs from the first embodiment in the control of the movement speed of the nozzle 61.

FIG. 11 shows temporal changes in the movement speed of the nozzle 61 in the third embodiment. In the third embodiment, the controller 101 accelerates the relative movement speed of the nozzle 61 from the first movement speed v1 to the second movement speed v2, and then further accelerates the relative movement speed of the nozzle 61 to a third movement speed v3, which is greater than the second movement speed v2, as shown in FIG. 11. That is, in the third embodiment, the controller 101 increases the movement speed of the nozzle 61 multiple times.

When the movement speed of the nozzle 61 is increased multiple times as described above, to reduce the movement speed of the nozzle 61 from the third movement speed v3 to the first movement speed v1, the controller 101 temporarily reduces the movement speed from the third movement speed v3 to the second movement speed v2 and then reduces the movement speed from the second movement speed v2 to the first movement speed v1, instead of directly reducing the movement speed from the third movement speed v3 to the first movement speed v1.

In the third embodiment, the controller 101 moves the plunger 77 in the branch channel 76 to perform the operation of delivering the plasticized material from the branch channel 76 to the channel 69 in the acceleration segment and the operation of suctioning the plasticized material from the channel 69 to the branch channel 76 in the deceleration segment, as in the first embodiment. When the plunger 77 is thus controlled, the stepwise deceleration readily allows the total amount of movement of the plunger 77 in the acceleration segment to match with the total amount of movement of the plunger 77 in the deceleration segment, as shown in FIG. 11, as in the acceleration of the nozzle 61. The thus operating controller 101 can suppress a situation in which the amount of movement of the plunger 77 in the direction toward the channel 69 and the amount of movement of the plunger 77 in the direction away from the channel 69 deviate from each other. As a result, even when the movement speed of the nozzle 61 is changed in multiple stages, the position of the plunger 77 can be accurately controlled over a long period of time. As a result, the shaping accuracy of the three-dimensionally shaped object can be increased.

### D. Other Embodiments

(D1) In the embodiments described above, the controller 101 performs both the first operation and the second operation in the three-dimensional shaping process. The controller 101 may instead perform only one of the first operation and the second operation.

(D2) In the embodiments described above, the controller 101 performs the delivery operation with the aid of the plunger 77 along with the first operation in the segment in which the nozzle 61 is accelerated, and performs the suction operation with the aid of the plunger 77 along with the second operation in the segment in which the nozzle 61 is decelerated. The controller 101 may instead not perform one of the delivery operation and the suction operation with the aid of the plunger 77. The controller 101 may still instead perform neither the delivery operation nor the suction operation with the aid of the plunger 77. When neither the delivery operation nor the suction operation is performed, the three-dimensionally shaping apparatus 100 may not include the plunger 77.

(D3) In the embodiments described above, the controller 101 carries out both the process of transmitting to the suction/delivery section 75 the operation instruction to move the plunger 77 before the timing at which the rotational speed of the screw 40 reaches the second speed R2, and the process of transmitting to the suction/delivery section 75 the operation instruction to move the plunger 77 before the timing at which the rotational speed of the screw 40 reaches the fifth speed R5. The controller 101 may instead carry out only one of these processes or may not carry out both the processes.

(D4) In the embodiments described above, the screw 40 is configured with a flat screw. Instead, the screw 40 may not be configured with a flat screw, and may be configured with an in-line screw.

### E. Other Aspects

The present disclosure is not limited to the embodiments described above, and may be achieved with various configurations without departing from the intent of the present disclosure. For example, to solve some or all of the problems described above, or to achieve some or all of the effects described above, technical features of the embodiments that correspond to the technical features in each of the following aspects can be replaced or combined as appropriate. The technical features can be deleted as appropriate unless described as essential technical features in the present specification.

(1) According to a first aspect of the present disclosure, a three-dimensionally shaping apparatus is provided. The three-dimensionally shaping apparatus includes a plasticizer that includes a screw and a motor that rotates the screw and plasticizes a material to produce a plasticized material; a nozzle that has a nozzle opening and discharges the plasticized material; and a controller that controls the plasticizer, and the controller performs at least one of a first operation and a second operation, the first operation adjusting a rotational speed of the screw from a first speed to a second speed greater than the first speed and then adjusting the rotational speed of the screw to a third speed greater than the first speed but smaller than the second speed in order to adjust a discharge quantity of the plasticized material discharged from the nozzle from a first discharge quantity to a second discharge quantity greater than the first discharge quantity, the second operation adjusting the rotational speed of the screw from a fourth speed to a fifth speed smaller than the fourth speed and then adjusting the rotational speed of the screw to a sixth speed greater than the fifth speed but smaller than the fourth speed in order to adjust the discharge quantity of the plasticized material discharged from the nozzle from a third discharge quantity to a fourth discharge quantity smaller than the third discharge quantity. According to the aspect described above, when the discharge quantity is changed, the changed discharge quantity can be quickly stabilized.

(2) In the aspect described above, in the first operation, the controller may adjust the rotational speed of the screw to the second speed, then adjust the rotational speed to a seventh speed smaller than the second speed but greater than the third speed, and then adjust the rotational speed from the seventh speed to the third speed. The aspect described above can suppress occurrence of an undershooting phenomenon in which the pressure of the plasticized material in a channel excessively decreases.

(3) In the aspect described above, the three-dimensionally shaping apparatus may further include the channel through which the plasticized material flows and which communicates with the nozzle opening; and a suction/delivery section including a branch channel coupled to the channel and a plunger disposed in the branch channel and configured to suction the plasticized material in the channel into the branch channel and deliver the plasticized material in the branch channel to the channel by changing a position of the plunger, and the controller may perform at least one of the operation of performing the first operation and the operation of performing the second operation, the first operation performed in an acceleration segment in which a relative movement speed of the nozzle is accelerated from a first movement speed to a second movement speed greater than the first movement speed, the second operation performed in a deceleration segment in which the relative movement speed of the nozzle is decelerated from the second movement speed to the first movement speed, and the controller may move the plunger in the branch channel to perform the operation of delivering the plasticized material from the branch channel to the channel in the acceleration segment and the operation of suctioning the plasticized material from the channel to the branch channel in the deceleration segment to match an amount of movement of the plunger in the acceleration segment with an amount of movement of the plunger in the deceleration segment. According to the aspect described above, since the position of the plunger can be accurately controlled over a long period of time, the shaping accuracy of a three-dimensionally shaped object can be increased.

(4) In the aspect described above, the controller may perform at least one of the process of transmitting to the suction/delivery section an operation instruction to move the plunger before a timing at which the rotational speed of the screw reaches the second speed when the first operation is performed in the acceleration segment, and the process of transmitting to the suction/delivery section the operation instruction to move the plunger before a timing at which the rotational speed of the screw reaches the fifth speed when the second operation is performed in the deceleration segment. The aspect described above can suppress occurrence of an insufficient discharge quantity or an excessive discharge quantity during the acceleration or deceleration of the movement speed of the nozzle.

(5) In the aspect described above, when the controller accelerates the relative movement speed of the nozzle from the first movement speed to the second movement speed, then further accelerate the relative movement speed to a third movement speed greater than the second movement speed, and to decelerate the movement speed from the third movement speed to the first movement speed, the controller may temporarily decelerate the movement speed from the third movement speed to the second movement speed, and then decelerate the movement speed from the second movement speed to the first movement speed. According to the aspect described above, even when the movement speed of the nozzle is changed in multiple stages, the position of the plunger can be accurately controlled over a long period of time, so that the shaping accuracy of the three-dimensionally shaped object can be increased.

The present disclosure is not limited to the three-dimensionally shaping apparatus described above, and can be implemented in various aspects such as a method for manufacturing a three-dimensionally shaped object, a computer program, and a non-transitory tangible recording medium in which a computer program is recorded in a computer-readable manner.

What is claimed is:

1. A three-dimensionally shaping apparatus comprising:
a plasticizer that includes a screw and a motor that rotates the screw and plasticizes a material to produce a plasticized material;
a nozzle that has a nozzle opening and discharges the plasticized material; and
a controller that controls the plasticizer,
wherein the controller performs at least one of a first operation and a second operation,
the first operation adjusting a rotational speed of the screw from a first speed to a second speed greater than the first speed and then adjusting the rotational speed of the screw to a third speed greater than the first speed but smaller than the second speed in order to adjust a discharge quantity of the plasticized material discharged from the nozzle from a first discharge quantity to a second discharge quantity greater than the first discharge quantity,
the second operation adjusting the rotational speed of the screw from a fourth speed to a fifth speed smaller than the fourth speed and then adjusting the rotational speed of the screw to a sixth speed greater than the fifth speed but smaller than the fourth speed in order to adjust the discharge quantity of the plasticized material discharged from the nozzle from a third discharge quantity to a fourth discharge quantity smaller than the third discharge quantity.

2. The three-dimensionally shaping apparatus according to claim 1, wherein
in the first operation, the controller adjusts the rotational speed of the screw to the second speed, then adjusts the rotational speed to a seventh speed smaller than the second speed but greater than the third speed, and then adjusts the rotational speed from the seventh speed to the third speed.

3. The three-dimensionally shaping apparatus according to claim 1, further comprising:
a channel through which the plasticized material flows and which communicates with the nozzle opening; and
a suction/delivery section including a branch channel coupled to the channel and a plunger disposed in the branch channel and configured to suction the plasticized material in the channel into the branch channel and deliver the plasticized material in the branch channel to the channel by changing a position of the plunger,
wherein the controller performs at least one of the operation of performing the first operation and the operation of performing the second operation,
the first operation performed in an acceleration segment in which a relative movement speed of the nozzle is accelerated from a first movement speed to a second movement speed greater than the first movement speed,
the second operation performed in a deceleration segment in which the relative movement speed of the nozzle is decelerated from the second movement speed to the first movement speed, and
the controller moves the plunger in the branch channel to perform the operation of delivering the plasticized material from the branch channel to the channel in the acceleration segment and the operation of suctioning the plasticized material from the channel to the branch channel in the deceleration segment to match an amount of movement of the plunger in the acceleration segment with an amount of movement of the plunger in the deceleration segment.

4. The three-dimensionally shaping apparatus according to claim 3, wherein
the controller performs at least one of
the process of transmitting to the suction/delivery section an operation instruction to move the plunger before a timing at which the rotational speed of the screw reaches the second speed when the first operation is performed in the acceleration segment, and
the process of transmitting to the suction/delivery section the operation instruction to move the plunger before a timing at which the rotational speed of the screw reaches the fifth speed when the second operation is performed in the deceleration segment.

5. The three-dimensionally shaping apparatus according to claim 3, wherein
the controller accelerates the relative movement speed of the nozzle from the first movement speed to the second movement speed, then further accelerates the relative movement speed to a third movement speed greater than the second movement speed, and
to decelerate the movement speed from the third movement speed to the first movement speed, the controller temporarily decelerates the movement speed from the third movement speed to the second movement speed, and then decelerates the movement speed from the second movement speed to the first movement speed.
